(19) United States
(12) Patent Application Publication
(10) Pub. No.: US 2016/0085750 A1
(43) Pub. Date: Mar. 24, 2016

(54) STORAGE APPARATUS AND STORAGE APPARATUS CONTROL METHOD

(71) Applicant: FUJITSU LIMITED, Kawasaki-shi (JP)

(72) Inventors: Suijin TAKETA, Kawasaki (JP); Yasuhiro Onda, Kawasaki (JP); TOSHIO IMAI, Toyama (JP)

(73) Assignee: FUJITSU LIMITED, Kawasaki-shi (JP)

(21) Appl. No.: 14/823,619

(22) Filed: Aug. 11, 2015

(30) Foreign Application Priority Data
Sep. 24, 2014 (JP) 2014-194335

(51) Int. Cl. G06F 17/30

(52) U.S. Cl. CPC G06F 17/303; G06F 17/30091; G06F 17/30598

(57) ABSTRACT

A storage apparatus includes a storage unit configured to include a plurality of tiers, a group management unit configured to manage files stored in any of the tiers in the storage unit by dividing the files into a plurality of groups, a movement target selection unit configured to select a group, out of the groups, which satisfies a tier movement condition as a movement target of the tier, and a file movement unit configured to move a subordinate file belonging to the group selected by the movement target selection unit, from a tier in which the subordinate file is stored to another tier.

### CROSS-REFERENCE TO RELATED APPLICATION

This application is based upon and claims the benefit of priority of the prior Japanese Patent Application No. 2014-194335, filed on Sep. 24, 2014, the entire contents of which are incorporated herein by reference.

### FIELD

The embodiments discussed herein are related to a storage apparatus and a storage apparatus control method.

### BACKGROUND

In recent years, the amount of data that computers treat has been increasing more and more. This also increases the storage capacity of a storage apparatus that a computer uses as a storage memory.

Storage media mounted to the storage apparatus vary from each other in performance. A high performance storage medium, such as a solid state drive (SSD) or a serial attached small computer system interface (SCSI) (SAS) disk device, is generally expensive, and accordingly it is quite difficult to use them to secure a large capacity. In contrast, a low performance storage medium, such as a nearline serial advanced technology attachment (SATA) disk device is inexpensive, and accordingly it is quite easy to use them to secure a large capacity.

Accordingly, in order to cope with increase in storage capacity and achieve cost reduction, storage apparatuses are now often build with storage media having different performances by considering the cost balance and the storage capacity. A storage apparatus equipped with storage media having different performances in this manner is referred to as a tiered storage apparatus. In this case, a group of storage media classified by performance among different performances corresponds to a tier.

In the tiered storage apparatus, an optimal file arrangement and transparent accesses to the storage media having different performances are desired. In order to meet those desires, the tiered storage apparatus performs layering processing in which data in a file with a high access frequency is located in a higher-speed storage medium, and data in a file with a low access frequency is located in a lower-speed storage medium.

As a relocation method of data in the tiered storage apparatus, for example, there are two methods called a tier movement type and a caching type. A storage apparatus of the tier movement type relocates a file with a high access frequency in higher-speed storage medium, and relocates a file with a low access frequency in a lower-speed storage medium. Meanwhile, a storage apparatus of the caching type utilizes a high-speed storage medium as a cache. Specifically, the storage apparatus of the caching type locates a file with a high access frequency in a high-speed storage medium while placing all the files in a low-speed storage medium, and deletes a file from the high-speed storage medium when the access frequency of the file decreases.

Both of the storage apparatuses of the tier movement type and the caching type check an access status of each file, and thereafter locate the file in a suitable position. Hereinafter, movement of a file by the storage apparatus of the tier movement type and the caching type is called relocation of a file.

Determination conditions for executing the relocation of the files are given by setting demotion and promotion policies which are customizable by a user. Herein, the demotion indicates movement of a file located in a higher-level tier to a low-level tier or deletion of a file located in a higher-level tier used as a cache. Meanwhile, the promotion indicates movement of a file located in a low-level tier to a higher-level tier, or copy of the file to a higher-level tier for use as a cache, in other words, caching. In addition, the policy is setting information in which a condition for determining whether the demotion or the promotion is to be performed is recorded in units of files.

For example, the demotion policy may be set in units of files such that a file with elapsed days from a last access exceeding a predetermined number of elapsed days determined in advance is to be demoted to a low-level tier or deleted from the cache. In this example, a last access time included in metadata of each file is used for determination of relocation. The metadata is information including management information on a file, such as a creation date/time, an author, and a data format. Meanwhile, the promotion policy may be set such that a file with the number of accesses per unit time exceeding a threshold value determined in advance is to be promoted or copied to a higher-level tier. In this example, a value with the number of references for every file is counted by referring to a file change log (FCL) is used for determination of relocation. Herein, the FCL is a repository in which reading and writing which are accessed to a file in a file system are recorded.

As for such a file relocation technique, proposed is a conventional technique of monitoring an access frequency in units of files, extracting a disk device to which loads are concentrated, and distributing the loads. Moreover, proposed is a conventional technique of migrating data between file servers based on a migration policy set by a person in charge.

The above-described techniques are disclosed, for example, in Japanese Examined Patent Application Publication No. 08-20990, Japanese Laid-open Patent Publication No. 2005-215715, and Japanese Laid-open Patent Publication No. 2010-257095.

However, managing the promotion and the demotion in units of files increases the processing time as the number of files increases. For example, in the case of determining the demotion described above in which a determination is made by checking the last reference date/time of a file, metadata of all the files is referred, thereby increasing the processing time. Meanwhile, in the case of determining the promotion described above in which a determination is made by analyzing a FCL, the increased number of target files results in the enormous FCL, thereby also increasing the analysis processing time. Moreover, searching enormous metadata or analyzing an enormous FCL may result in the highly-loaded utilization of a central processing unit (CPU).

Hence, in an environment in which enormous files are stored or an environment in which a large amount of accesses are made per unit time, such for example as a case where files more than hundreds of millions of files or billions of files are handled, a continuous highly-loaded state for a long period of time may hinder operational accesses. In addition, for example, 24 hours or longer may be spent in the search processing of the metadata or the analysis processing of the FCL, and the processing for one session may fail to be completed within a day.

### SUMMARY

According to an aspect of the invention, an apparatus includes a storage unit configured to include a plurality of tiers, a group management unit configured to manage files stored in any of the tiers in the storage unit by dividing the files into a plurality of groups, a movement target selection unit configured to select a group, out of the groups, which satisfies a tier movement condition as a movement target of the tier, and a file movement unit configured to move a subordinate file belonging to the group selected by the movement target selection unit, from a tier in which the subordinate file is stored to another tier.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a storage apparatus according to a first embodiment;

FIG. 2 is a diagram illustrating a relation between files on a logic tree and files on a tier storage;

FIG. 3 is a schematic view when multiple file systems are present in the storage apparatus;

FIG. 4 is a view for explaining a relocation policy definition;

FIG. 5 is a view illustrating an example of a FCL;

FIG. 6 is a view for explaining metadata;

FIG. 7 is a view of an example of a tier management table;

FIG. 8 is a view of an example of a logic tree when relocation target directories are set;

FIG. 9 is a view of an example of a logic tree when relocation exemption target directories are set;

FIG. 10 is a view of an example where a relocation target directory is descended;

FIG. 11 is a view of an example where a relocation target directory for which a directly below file is present is descended;

FIG. 12 is a view of an example where a relocation target directory is ascended;

FIG. 13 is a view of an example where a relocation target directory for which an equal-ranked file is present is ascended;

FIG. 14 is a view illustrating a state of two relocation target directories;

FIG. 15 is a flowchart of relocation processing of files by the storage apparatus according to the first embodiment;

FIG. 16 is a flowchart of descending processing of a directory tier;

FIG. 17 is a flowchart of ascending processing of a directory tier;

FIG. 18 is a view of an example of a tier management table according to a second embodiment;

FIG. 19 is a view of an example where a relocation target directory is descended by grouping;

FIG. 20 is a flowchart of relocation processing of files by a storage apparatus according to the second embodiment; and

FIG. 21 is a hardware configuration diagram of the storage apparatus.

### DESCRIPTION OF EMBODIMENTS

Hereinafter, embodiments of a storage apparatus and a storage apparatus control method disclosed in the present application are explained in details based on the drawings. Note that, the following embodiments do not limit the storage apparatus and the storage apparatus control method disclosed in the present application.

### First Embodiment

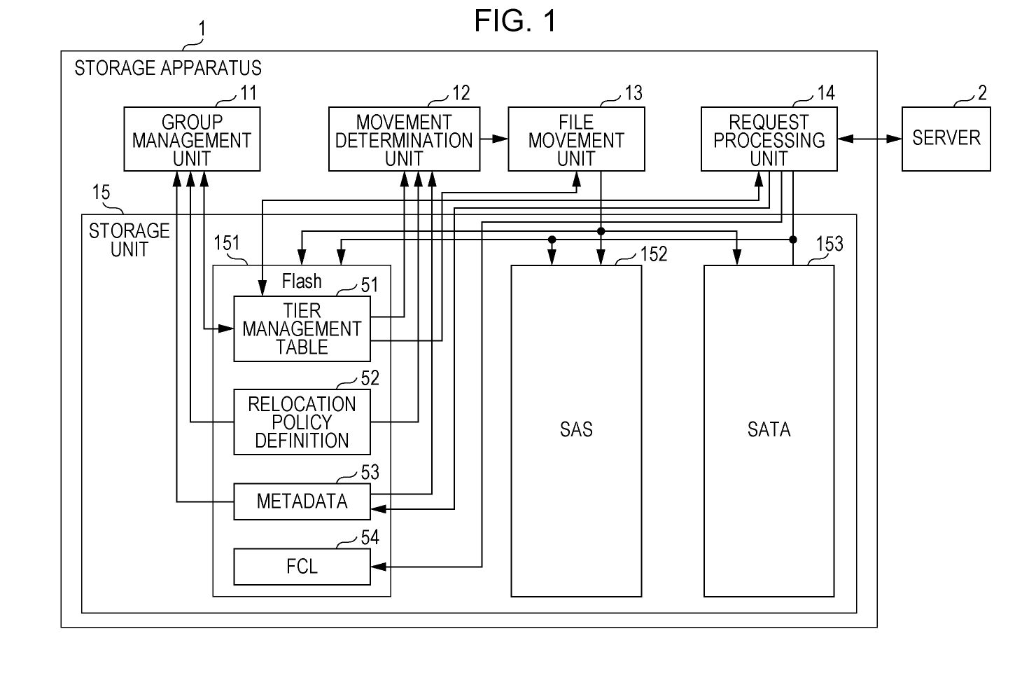

FIG. 1 is a block diagram of a storage apparatus according to a first embodiment. As illustrated in FIG. 1, a storage apparatus 1 according to the first embodiment includes a group management unit 11, a movement determination unit 12, a file movement unit 13, a request processing unit 14, and a storage unit 15.

The storage unit 15 includes a Flash 151, an SAS 152, and an SATA 153 in the first embodiment. Herein, although a case where the storage unit 15 includes storage media of three different types is explained in the first embodiment, the types of the storage media are not specially limited as long as the storage unit 15 includes storage media of two or more types and is layered.

Hereinafter, tiers of the Flash 151, the SAS 152, and the SATA 153 are respectively called a Tier #1, a Tier #2, and a Tier #3. In other words, the Tier #1 is a tire of a highest-speed storage medium, and stores therein a file requested to perform processing at high speed. The Tier #2 is a tier of a second highest-speed storage medium, and stores therein a file requested to perform processing at a processing speed higher than that of a file stored in the Tier #3 while the processing speed may be slower than that of the file stored in the Tier #1. The Tier #3 is a tier of a lowest-speed storage medium, and stores therein a file for which high-speed processing is not requested. Herein, the order of the Tier #1 is set as the highest level, and the order of the Tier #3 is set as the lowest level. Hereinafter, relocation of a file to a higher-level tier is referred to as “promotion” of the file. Meanwhile, relocation of a file to a lower-level tier is referred to as “demotion” of the file.

In addition, the storage apparatus 1 according to the first embodiment performs relocation of files in units of directories. Accordingly, a directory that is a determination target as to whether a file present subordinate thereto is moved is referred to as “relocation target directory”. Hereinafter, a tier to which a directory belongs in a logic tree indicating a tier structure of directories is called “directory tier”. In other words, a directory tier at a higher-level is positioned at a higher level in the logic tree. Hereinafter, changing a relocation target directory to a directory at a higher-level directory tier is referred to as “ascending” of the relocation target directory. Meanwhile, changing a relocation target directory to a directory at a lower-level directory is referred to as “descending” of the relocation target directory. In addition, promotion and demotion of the relocation target directory are collectively referred to as “migration”.

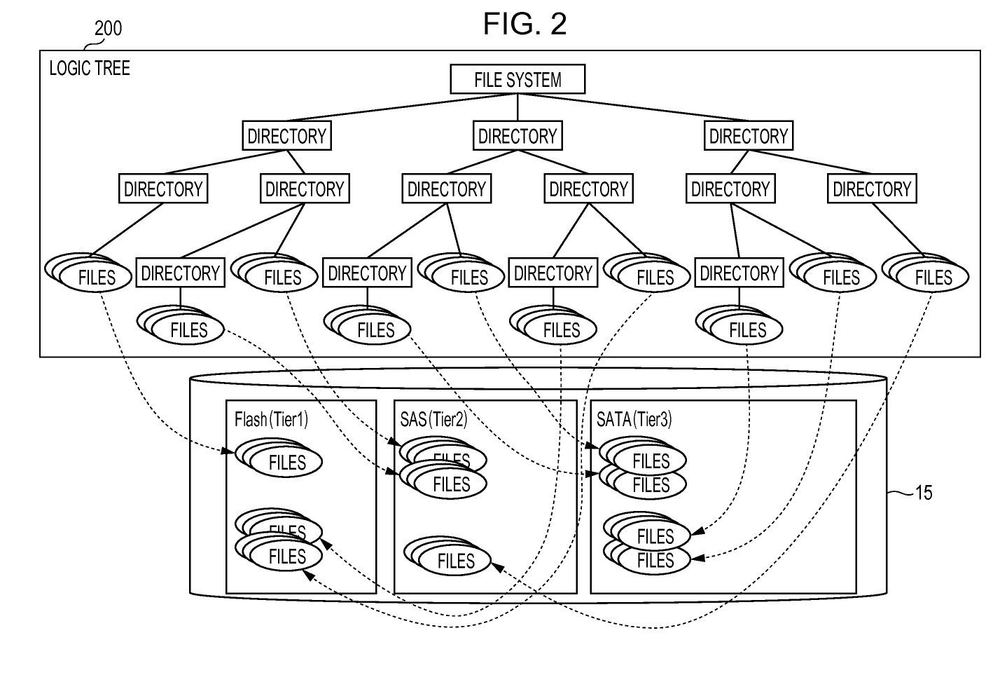

FIG. 2 is a diagram illustrating a relation between files on a logic tree and files on a tier storage. FIG. 2 illustrates a logic tree 200 indicating a logical tier structure of directories, in an upper part, and the storage unit 15 serving as a tier storage in the storage apparatus 1, in a lower part. Files in the logic tree 200 are physically stored in corresponding storage media indicated by dashed line arrows, respectively.

In the first embodiment, relocation of files is performed in units of directories in the logic tree 200. Specifically, as is explained below, in the first embodiment, a directory to be a relocation target directory that is a target of relocation of files is determined, and relocation of files is performed for every relocation target directory. Herein, changing a relocation target directory in the logic tree 200 and changing a tier which physically stores therein files are independent of each other.

In the first embodiment, the Flash 151 stores therein a tier management table 51, a relocation policy definition 52, metadata 53, and an FCL 54.

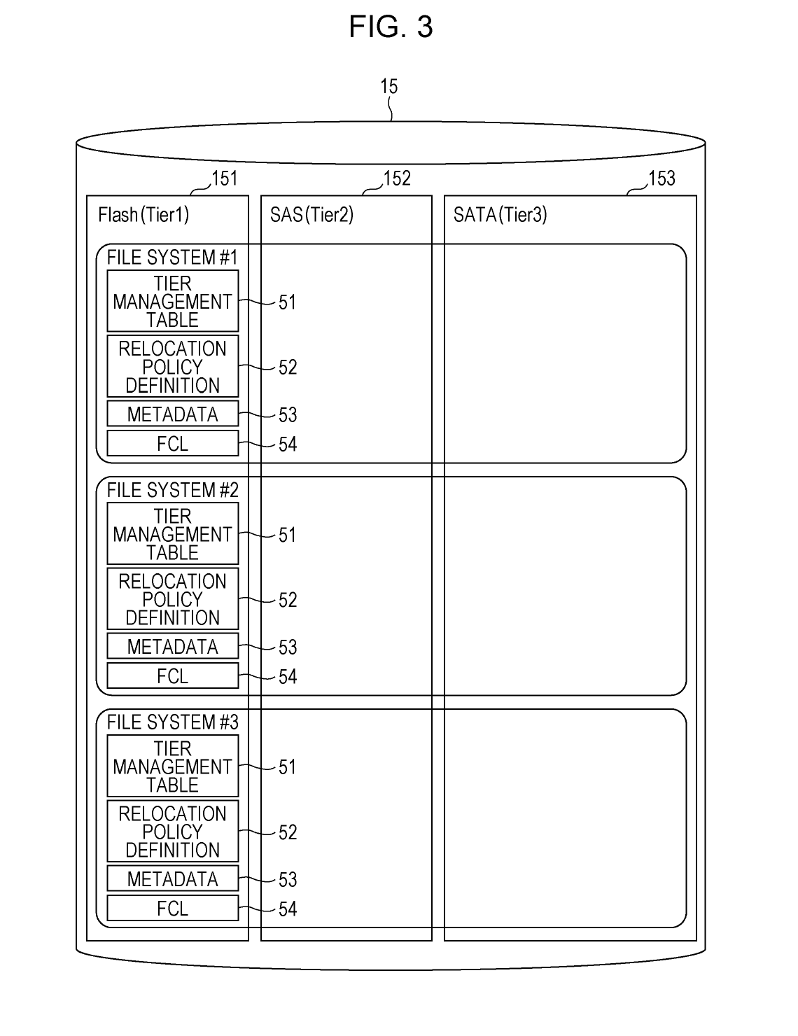

Herein, the storage apparatus 1 includes multiple file systems. FIG. 3 is a schematic view when multiple file systems are present in the storage apparatus 1. The tier management table 51, the relocation policy definition 52, the metadata 53, and the FCL 54 are prepared for every file system, as illustrated in FIG. 3. For example, when three types of file systems #1 to #3 are present as in FIG. 3, the tier management table 51, the relocation policy definition 52, the metadata 53, and the FCL 54 are present for each of the file systems #1 to #3. In this case, each of the file systems #1 to #3 is assigned with the Flash 151, the SAS 152, and the SATA 153, and is layered. Further, the Flash 151 in each of the file systems #1 to #3 stores therein the tier management table 51, the relocation policy definition 52, the metadata 53, and the FCL 54.

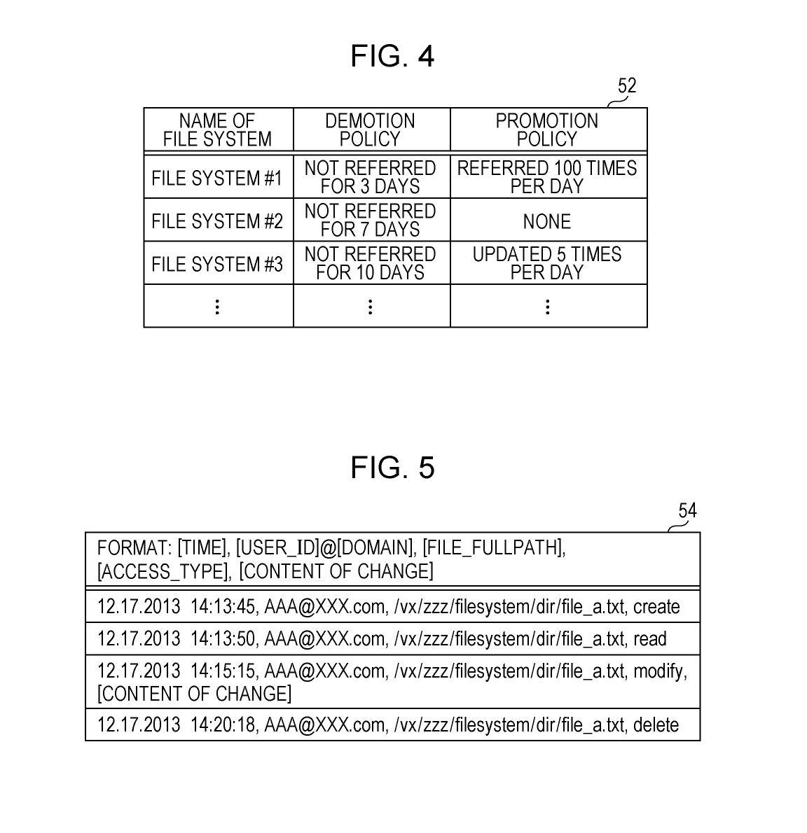

FIG. 4 is a view for explaining a relocation policy definition. The relocation policy definition 52 is a condition for determining whether to relocate files under a relocation target directory. In the first embodiment, the relocation policy definition 52 is applied to all the relocation target directories present in one file system. For example, a demotion policy may be set such that if files under a given directory are not referred to during predetermined days, the files under the given directory are relocated to a lower-level Tier. Moreover, for example, a promotion policy may be set such that if a total number of references made to files under a given directory is not less than a predetermined number of times, the files under the given directory are promoted.

In addition to the above, the relocation policy definition 52 may use another reference as long as it may determine a usage frequency of files under a directory. For example, the demotion policy may preferably be set utilizing a last update date/time. Alternatively, the promotion policy may preferably be set using an access frequency in which the number of reads and the number of writes, per unit time, are distinguished. Alternatively, the promotion policy may preferably be set so as to promote the files if a total amount of read files under the relocation target directory exceeds a threshold value. Alternatively, the promotion policy may preferably be set so as to promote the files if a total amount of written files under the relocation target directory exceeds a threshold value. Moreover, if the number of references is used, for example, the average number of accesses to each file under the relocation target directory may also be used.

FIG. 5 is a view illustrating an example of an FCL. As illustrated in FIG. 5, for example, one access to each file is recorded in one line in the FCL 54. Further, for example, an access time, information on a user who made the access, a path of a file, and a type of the access are recorded in the FCL 54. When any change is made, a content of the change is further recorded in the FCL 54. Herein, in the first embodiment, the FCL 54 is not used for relocation of files, so that the storage apparatus 1 may preferably not include the FCL 54.

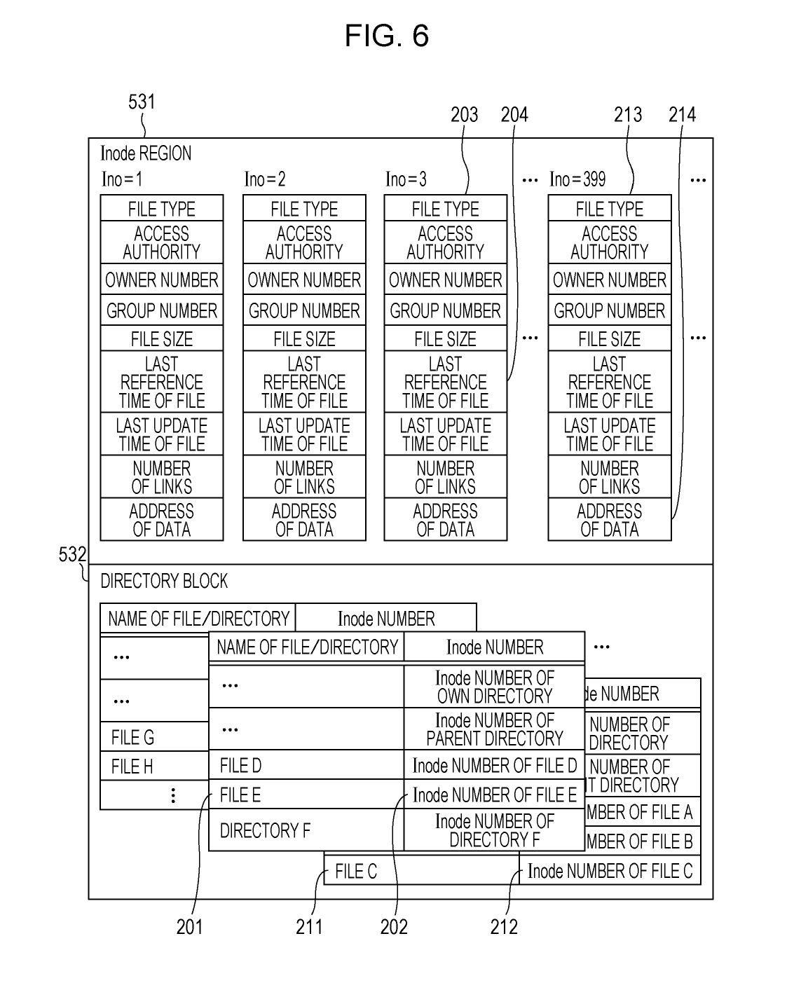

FIG. 6 is a view for explaining metadata. As illustrated in FIG. 6, the metadata includes an inode region 531 and a directory block 532. The inode is management information on each file and each directory.

The inode region 531 is a region in which the inode is stored. In the inode of a file, recorded are file management information such as an access authority or an owner of the file, a last reference date/time, and a last update date/time, and information such as an address in which data of the file is stored. In the inode of a directory, recorded is directory management information such as an access authority and an owner of the directory, a last reference date/time, and a last update date/time. In addition, in the inode of the directory, recorded is information such as a name of a file and a name of a directory present in the directory, and an address in which data of the inode is stored.

Moreover, the directory block 532 is a region in which, in units of directories, a name of a file and a name of a directory present in the directory, and information on the inode are stored.

For example, an inode number 202 of a file E in association with a file name 201 of the file E is stored in the directory block 532. Further, if the inode number 202 of the file E is “3”, information on the file E is stored in an entry 203 of ino=3 in the inode region 531. Further, a file last time 204 and the like are stored in the entry 203.

For example, an inode number 212 of a file C in association with a file name 211 of the file C is stored in the directory block 532. Further, if the inode number 212 of the file C is “399”, information on the file C is stored in an entry 213 of ino=399 in the inode region 531. Further, a data address 214 and the like are stored in the entry 213.

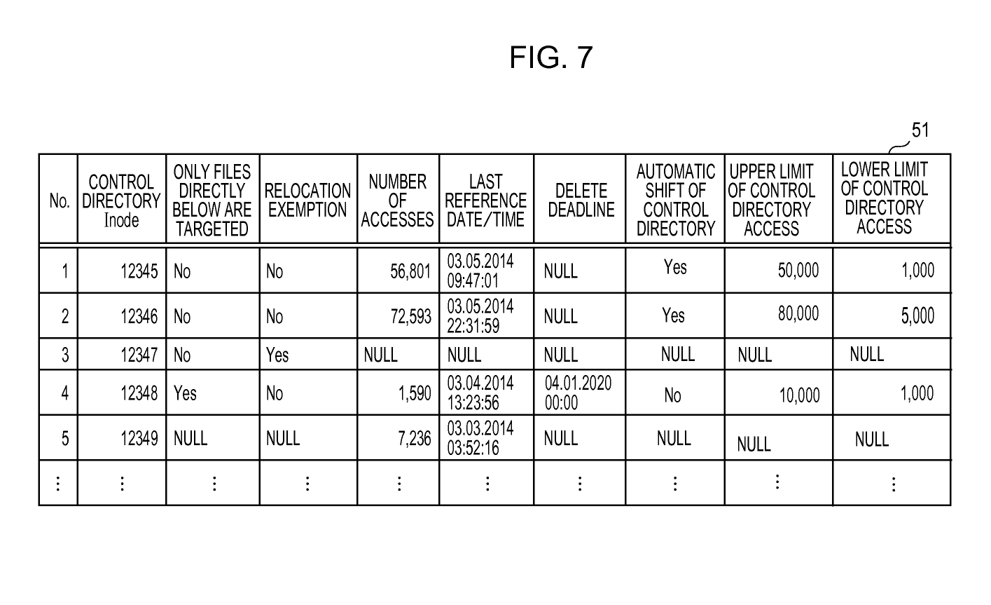

FIG. 7 is a view of an example of a tier management table. The tier management table 51 holds relocation determination information relating to a relocation target directory, for every file system, in a format illustrated in FIG. 7, for example.

“No.” is information to manage sequential numbers in the tier management table 51. When a new directory is newly selected as a relocation target directory, the group management unit 11 assigns a new number in “No.”.

“CONTROL DIRECTORY Inode” is a value set by a person in charge, and an inode number of the relocation target directory. When files are relocated, the file movement unit 13, which is described later, specifies files under the directory based on the number in the control directory inode.

“ONLY FILES DIRECTLY BELOW ARE TARGETED” is information indicating whether files directly below the relocation target directory, in other words, only files which are not included in a directory subordinate to relocation target directory, but are directly subordinate to the relocation target directory are to be set as a relocation target. Hereinafter, a file directly below the directory is referred to as “directly below file”. If this information is “Yes”, only a file directly below the relocation target directory is a relocation target. If this information is “No”, a file included in a sub-directory subordinate to the relocation target directory also is a target of the relocation. “ONLY FILES DIRECTLY BELOW ARE TARGETED” is information registered by the group management unit 11 in accordance with the practical use.

“RELOCATION EXEMPTION” is information indicating a directory in which subordinate files are to be exempted from relocation. If this information is “Yes”, the directory is excluded from the relocation target, and is continuously held by a Tier to which the directory belongs. If this information is “No”, the directory is a relocation target. In the first embodiment, when a practical use of the storage apparatus 1 is started, a person in charge sets a relocation target directory and a relocation exemption target directory. The group management unit 11, which is described later, then records the setting information set by the person in charge in the tier management table 51. Further, when no relocation exemption target is provided in the storage apparatus 1, the group management unit 11 may not manage this element.

“NUMBER OF ACCESSES” is a grand total of the numbers of accesses to subordinate files managed by the relocation target directory. This information is obtained by the group management unit 11 which accumulates the numbers of accesses to subordinate files managed by the relocation target directory. After the relocation processing is completed, the group management unit 11 initializes this information. Further, when the number of accesses is not used for the relocation of files, the group management unit 11 may not manage this element.

“LAST REFERENCE DATE/TIME” is a last reference date/time to a file managed by the relocation target directory. Every time the file managed by the relocation target directory is referred, the group management unit 11 updates the last reference date/time related to the relocation target directory. Further, when the last reference date/time is not used for the relocation of files, the group management unit 11 may not manage this element.

“DELETE DEADLINE” is a value set by the person in charge, and designates elapsed days from a last reference date/time or a designated date/time. In a case of elapsed days from a last reference date/time, for example, when “+365” is designated, the file movement unit 13 deletes the file having been elapsed for 365 days from the last reference date/time. Moreover, in a case of the designated date/time, for example, when “2020.04.01 0:00” is designated, the file movement unit 13 deletes the file having been passed over the designated date/time. In this manner, the file movement unit 13 deletes the file having passed over the set deadline when the relocation processing is performed. If this information is “NULL”, files managed by the relocation target directory are not deleted. Further, when no delete deadline is provided in the storage apparatus 1, the group management unit 11 may not manage this element.

“AUTOMATIC SHIFT OF CONTROL DIRECTORY” is a value set by the person in charge, and is a value designating whether a relocation target directory is automatically to be ascended or descended to another directory tier. If this information is “Yes”, the group management unit 11 causes the relocation target directory to shift in accordance with an upper limit value and a lower limit value of a designated access. If this information is “No”, the relocation target directory is fixed to the original directory. If automatic shift of the relocation target directory is not executed in units of storage apparatuses 1 or in units of file systems, the group management unit 11 may not manage this element.

“UPPER LIMIT OF CONTROL DIRECTORY ACCESS” is an upper limit value set by the person in charge, and is used for migration determination of the relocation target directory. When automatic shift of the relocation target directory using this information is not executed in units of storage apparatuses 1 or in units of file systems, the group management unit 11 may not manage this element.

“LOWER LIMIT OF CONTROL DIRECTORY ACCESS” is a lower limit value set by the person in charge, and is used for migration determination of the relocation target directory. When automatic shift of the relocation target directory using this information is not executed in units of storage apparatuses 1 or in units of file systems, the group management unit 11 may not manage this element.

The person in charge is capable of customizing the tier management table 51. For example, the person in charge may add a last update date/time, an access frequency for each of the number of reads and the number of writes per unit time, and a total read size or a total written size of a file to be managed to the tier management table 51. In this manner, addition of new information to the tier management table 51 enables the storage apparatus 1 to utilize these pieces of added information for the relocation determination.

The group management unit 11 registers information on a relocation target directory in the tier management table 51 to perform grouping of the relocation target directories, promotion, and demotion. Hereinafter, the management of the tier management table 51 by the group management unit 11 is specifically explained.

The group management unit 11 is inputted with, when a practical use of relocation of files is started, an inode of a directory, information on a relocation exemption target, information on a delete deadline, information on automatic shift of the control directory, an upper limit value and a lower limit value of the number of accesses, from the person in charge. The group management unit 11 then gives a sequential number for every relocation target directory in the tier management table 51. The group management unit 11 then registers an inode, information on a relocation exemption target, information on a delete deadline, information on automatic shift of the control directory, an upper limit value and a lower limit value of the number of accesses of each relocation target directory with respect to the given number.

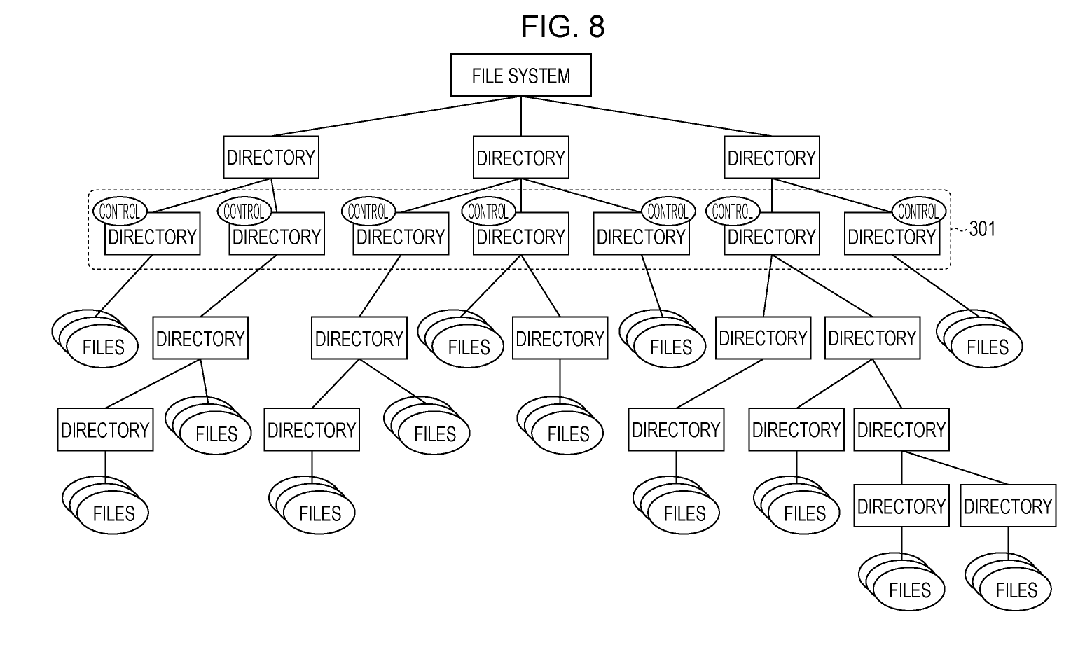

For example, FIG. 8 is a view of an example of a logic tree when relocation target directories are set. FIG. 8 illustrates a case where all directories which are surrounded by a frame 301 and present in the same tier are set as relocation target directories. As illustrated in FIG. 8, each directory with a character of “CONTROL” on a left portion thereof represents a relocation target directory. When a relocation target directory is designated, it is possible to designate a specific directory as a relocation target directory, or is also possible to collectively designate directories included in a tier of directories as a relocation target directory as in FIG. 8.

When relocation of files is performed, all the files under the relocation target directory collectively become a target of the relocation. In the case of FIG. 8, all the files belong to the relocation target directories.

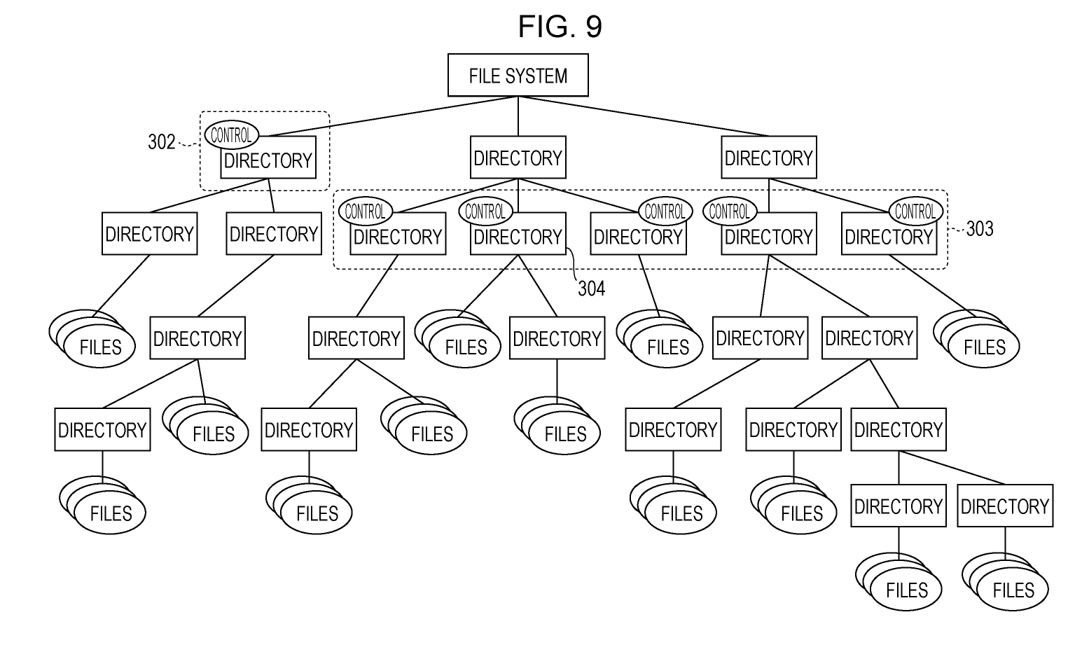

FIG. 9 is a view of an example of a logic tree when a relocation exemption target directory is set. In FIG. 9, directories surrounded by a frame 303 are relocation target directories. Further, a directory surrounded by a frame 302 is a relocation exemption target directory. In this case, files under the directories surrounded by the frame 303 become files as targets of the relocation. Meanwhile, files under the directory surrounded by the frame 302 are excluded from the target of the relocation, and are stored in the held Tier.

Herein, when a relocation target directory and a relocation exemption target directory are mistakenly set in the identical directory, or a directory which does not belong to either a relocation target directory or a relocation exemption target directory is present, the group management unit 11 corrects the directory so as to belong to either one. Accordingly, an example of a correction method of a relocation target directory and a relocation exemption target directory by the group management unit 11 is explained below.

For example, the group management unit 11 determines whether all files except files under a directory set as a relocation exemption target belong to any of relocation target directories. If a file which does not belong to any relocation target directories is present, the group management unit 11 assigns and corrects a directory in the highest-level tier, out of directories which do not overlap with already set relocation target directories, as a relocation target directory.

For example, a case where only a directory 304, out of the directories surrounded by the frame 303, is not set as a relocation target directory is explained. In that case, the group management unit 11 specifies the directory 304 that is a directory in the highest-level tier, out of directories which do not overlap with other relocation target directories, and corrects the directory 304 by assigning as a relocation target directory.

Moreover, if a single directory is coincident with both of a relocation exemption target directory and a relocation target, the group management unit 11 corrects, for example, the relocation target directory so as to give a priority to the relocation exemption target directory.

Upon starting a practical use of relocation of files, the group management unit 11 accumulates the numbers of accesses to the files managed by the relocation target directories registered in the tier management table 51, registers the accumulated value in the number of accesses. Moreover, the group management unit 11 updates the last reference date/time of the relocation target directory in the tier management table 51.

Subsequently, the group management unit 11 detects a relocation target directory with the number of accesses not less than an upper limit value. Meanwhile, the group management unit 11 does not detect a directory of “Yes” for the relocation exemption target directory or “No” for the automatic shift of control directory. Hereinafter, a relocation target directory with the number of accesses not less than the upper limit value is referred to as “descending target directory”. Next, the group management unit 11 uses the metadata 53 to determine whether a directory (hereinafter, referred to as “directly below directory”) is present directly below the descending target directory.

If a directly below directory is present, the group management unit 11 registers all directories directly below the descending target directory as relocation target directories in the tier management table 51. At this time, the group management unit 11 creates a row to which a new number is assigned in association with each directly below directory in the group management unit 11. The group management unit 11 then registers the directly below directory to which the setting information set to the descending target directory, such as the delete deadline, and the upper limit value and the lower limit value of the access is transferred, in the tier management table 51. The group management unit 11 then initializes information on the number of accesses and information on the last reference date/time.

In addition, the group management unit 11 uses the metadata 53 to determine whether a file directly below the descending target directory is present. If no directly below file is present, the group management unit 11 deletes the descending target directory from the tier management table 51.

On the other hand, if a directly below file is present, the group management unit 11 sets the column of “ONLY FILES DIRECTLY BELOW ARE TARGETED” of the descending target directory in the tier management table 51 as “Yes”, and causes the descending target directory to manage only the directly below file.

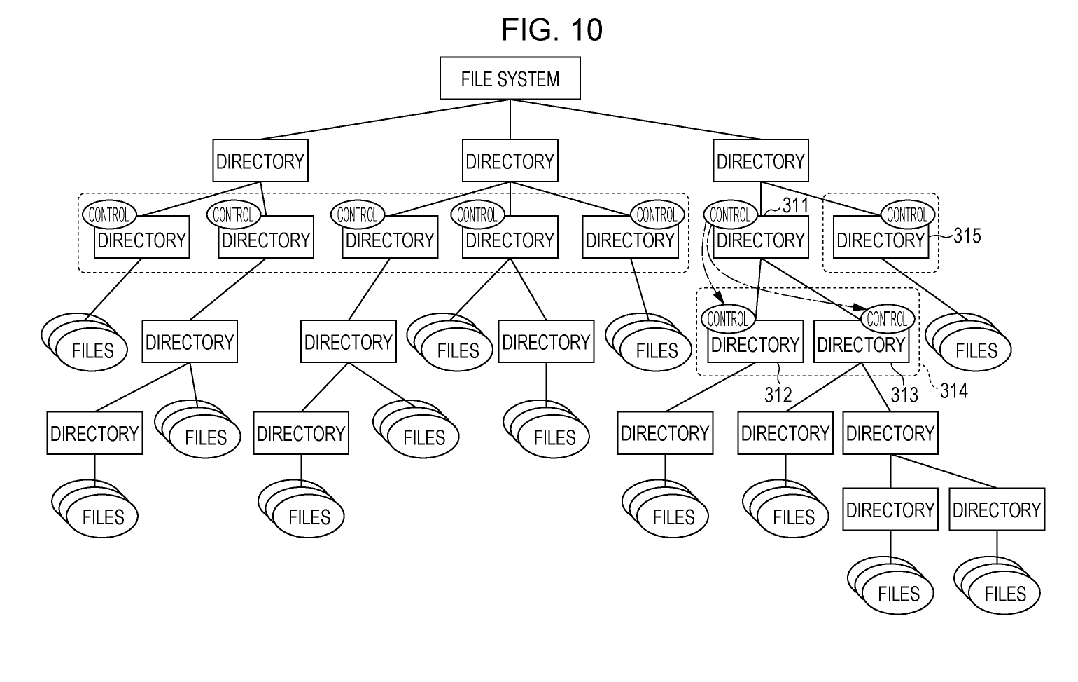

FIG. 10 is a view of an example where a relocation target directory is descended. When the number of accesses becomes not less than an upper limit value, and a directory 311 becomes a descending target directory, the group management unit 11 specifies directories 312 and 313 as directly below directories of the directory 311. The group management unit 11 then sets the directories 312 and 313 as relocation target directories. In this case, the directory 311 is not a relocation target directory anymore, and the directories 312 and 313 that are two directly below directories surrounded by a frame 314 become relocation target directories.

In addition, for example, in FIG. 10, when the number of accesses becomes not less than an upper limit value and a directory 315 becomes a descending target directory, the group management unit 11 checks that the directory 315 includes no directly below directory. In this case, the group management unit 11 causes the directory 315 to remain as a relocation target directory.

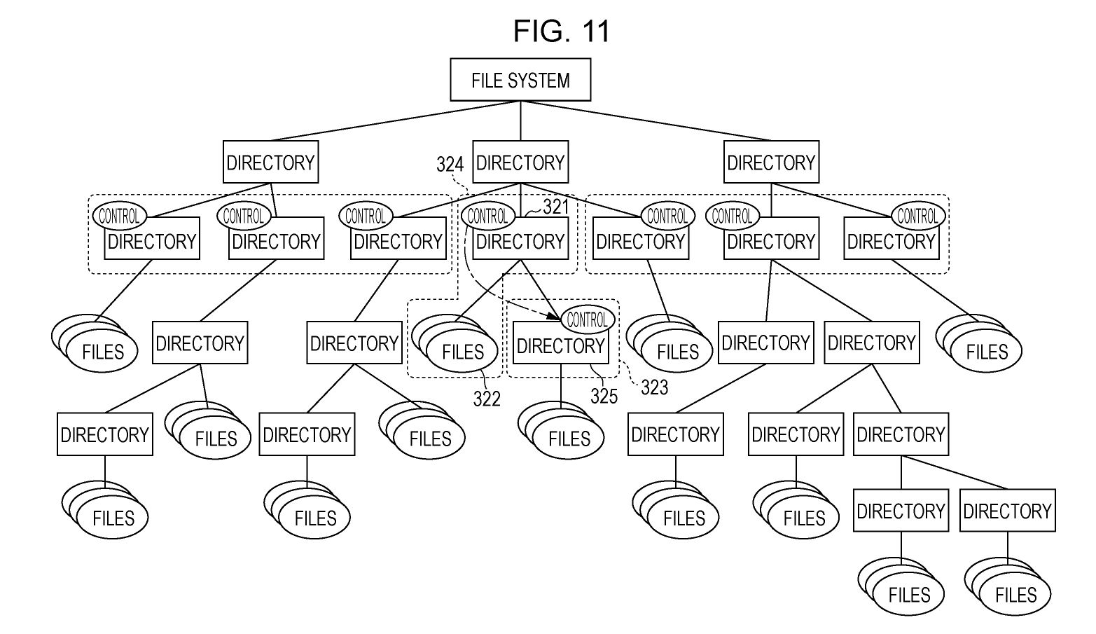

FIG. 11 is a view of an example where a relocation target directory for which a directly below file is present is descended. When the number of accesses becomes not less than an upper limit value and a directory 321 becomes a descending target directory, the group management unit 11 sets a directory 325 that is a directly below directory as a relocation target directory. In addition, the directory 321 includes directly below files 322, and thus the group management unit 11 sets the directory 321 as a relocation target directory which only sets the files 322 as a target of the relocation. In this case, a directory 325 surrounded a frame 323 becomes a relocation target directory, and a combination of the directory 321 and the files 322 surrounded by a frame 324 becomes a relocation target directory.

Subsequently, the group management unit 11 detects a relocation target directory with the number of accesses not more than a lower limit value. Meanwhile, the group management unit 11 does not detect a directory of “Yes” for the relocation exemption target directory or “No” for the automatic shift of control directory. Hereinafter, a relocation target directory with the number of accesses not more than the lower limit value is referred to as “ascending target directory”.

Next, the group management unit 11 determines whether a directory is present at a higher level of the ascending target directory, in other words, whether the higher level of the ascending target directory is the top of the file system.

If the higher level of the ascending target directory is the top of the file system, the group management unit 11 does not cause the relocation target directory to migrate.

On the other hand, if the higher level of the ascending target directory is not the top of the file system, the group management unit 11 determines whether there is an equal-ranked directory that is a directory under a directory to which the ascending target directory belongs and at the same tier. The equal-ranked directory is, in other words, a directory at the same level as the ascending target directory.

If an equal-ranked directory is present, the group management unit 11 determines whether all equal-ranked directories satisfy the number of accesses not more than the lower limit value. If any of the equal-ranked directories satisfies the number of accesses more than the lower limit value, the group management unit 11 does not cause the relocation target directory to migrate.

On the other hand, if none of the equal-ranked directories satisfies the number of accesses more than the lower limit value, the group management unit 11 registers a directly above a directory in a higher tier by one level than the ascending target directory in the tier management table 51 as a relocation target directory. At this time, the group management unit 11 creates a row to which a new number is assigned in association with each directly above directory in the group management unit 11. The group management unit 11 then registers the directly above directory to which the setting information set to the ascending target directory, such as the delete deadline, and the upper limit value and the lower limit value of the access is transferred, in the tier management table 51. The group management unit 11 then initializes information on the number of accesses and information on the last reference date/time.

In addition, the group management unit 11 deletes the ascending target directory and the equal-ranked directory from the tier management table 51.

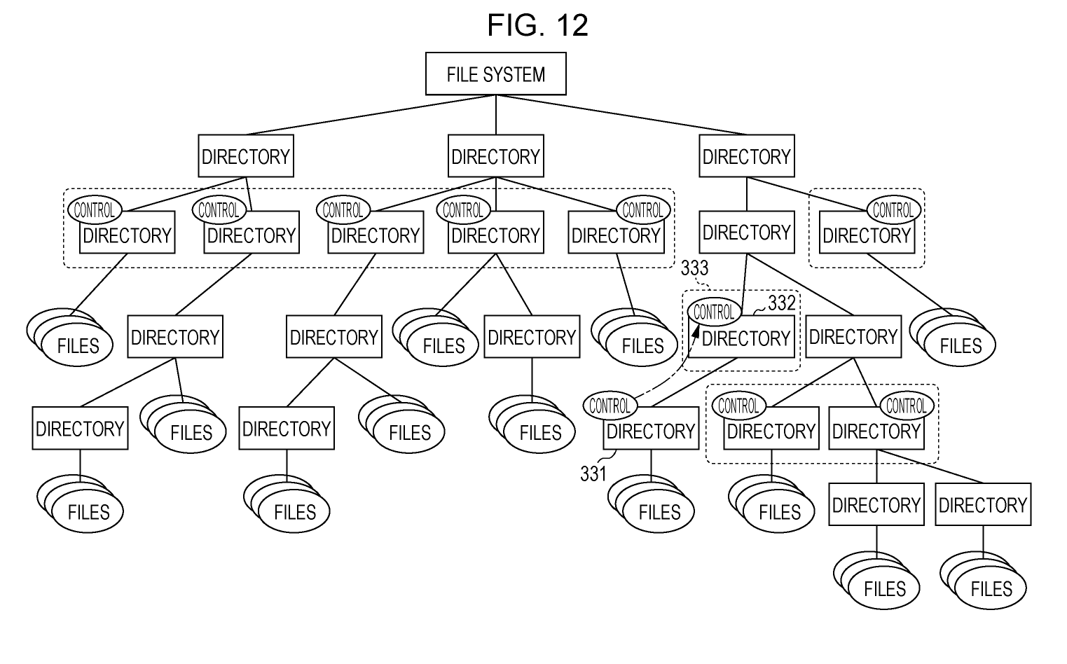

FIG. 12 is a view of an example where a relocation target directory is ascended. When the number of accesses becomes not less than an upper limit value, and a directory 331 becomes an ascending target directory, the group management unit 11 specifies a directory 332 as a directly above directory of the directory 331. The group management unit 11 sets the directory 332 as a relocation target directory. In this case, the directory 331 is not a relocation target directory anymore, and the directory 332 that is a directly above directory surrounded by a frame 333 becomes a relocation target directory.

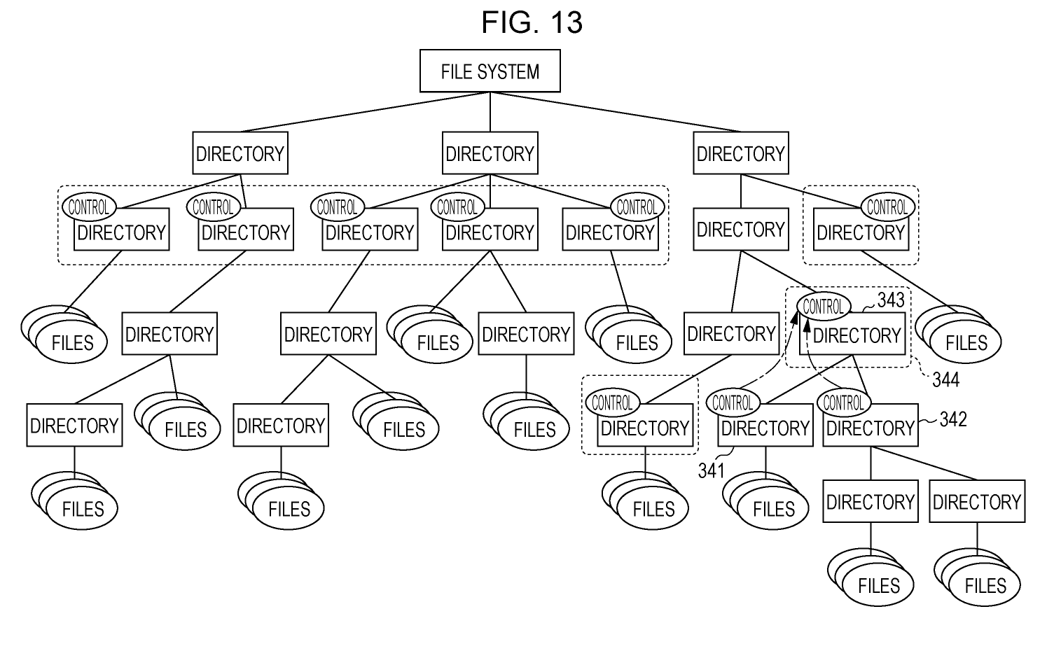

FIG. 13 is a view of an example where a relocation target directory for which an equal-ranked file is present is ascended. When the number of accesses becomes not more than a lower limit value, and a directory 341 becomes an ascending target directory, the group management unit 11 specifies a directory 342 that is an equal-ranked directory. Further, if the number of accesses of the directory 342 is not more than the lower limit value, the group management unit 11 sets a directory 343 that is a directly above directory of the directories 341 and 342 as a relocation target directory. In this case, the directory 343 surrounded by a frame 344 becomes a relocation target directory, and the directories 341 and 342 are not relocation target directories anymore.

As in the foregoing, the group management unit 11 descends a relocation target directory with the large number of accesses, and ascends a relocation target directory with the small number of accesses. This is because a highly granular determination is preferably performed when relocation of files is determined, however, it can be considered that the large number of accesses to files under the directory results in too many files serving as determination targets of the relocation. Accordingly, when the number of accesses is large, a relocation target directory is descended to reduce the number of files managed by each relocation target directory, thereby allowing the fine granularity of determination and the suitable relocation to be performed. Moreover, the granularity of determining relocation of files is preferably made large to reduce the load to the processing, however, it can be considered that the small number of accesses to files under the directory results in too few files serving as determination targets of the relocation. Accordingly, when the number of accesses is small, a relocation target directory is ascended to increase the number of files managed by each relocation target directory, thereby allowing the large granularity of determination and a load to the determination processing of the relocation to be reduced while performing the suitable relocation.

Referring back to FIG. 1, the explanation is continuously made. The movement determination unit 12 memorizes a schedule of execution of relocation of files. When a timing at the execution of relocation of files is arrived, the movement determination unit 12 refers to the tier management table 51 to specify a relocation target directory. In addition, the movement determination unit 12 acquires a promotion policy and a demotion policy in accordance with a file system as a target of the relocation from the relocation policy definition 52. Herein, although the explanation has been made in the case where the relocation of files is executed based on a schedule determined in advance in the first embodiment, the execution of the relocation of files is not limited thereto, but the movement determination unit 12 may preferably execute the relocation of files upon receiving an execution direction from a person in charge, for example. Further, the movement determination unit 12 extracts a relocation target directory which satisfies the promotion policy or the demotion policy as a relocation execution directory.

For example, when the total number of accesses not less than a threshold value for the total number is set as the promotion policy, the movement determination unit 12 acquires the number of accesses of each relocation target directory from the information on the tier management table 51. Next, the movement determination unit 12 extracts a relocation target directory with the acquired number of accesses not less than the threshold value for the total number as a relocation execution directory for which files are promoted.

Moreover, for example, when the average number of accesses not less than a threshold value for the average number is set as a promotion policy, the movement determination unit 12 acquires the number of files for every relocation target directory from the metadata 53. Next, the movement determination unit 12 obtains the average number of accesses by dividing the number of accesses of each relocation target directory recorded in the tier management table 51 by the number of files. Further, the movement determination unit 12 extracts a relocation target directory with the calculated average number of accesses not less than the threshold value for the average number as a relocation execution directory for which files are promoted.

Moreover, for example, when no reference during a predetermined period is set as a demotion policy, the movement determination unit 12 acquires a last reference date/time of each relocation target directory in the tier management table 51. Next, the movement determination unit 12 calculates the number of days from the acquired last reference date/time to the current date. The movement determination unit 12 then extracts a relocation execution directory with the calculated number of days not less than a predetermined period as a relocation execution directory for which files are demoted.

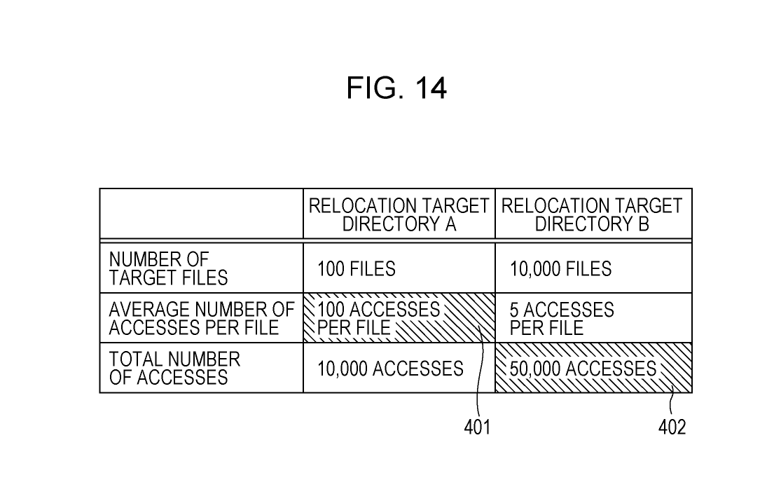

Further, in such determination processing of a relocation execution directory, a directory set as a relocation execution directory by the movement determination unit 12 depending on the setting condition for the demotion policy and the promotion policy. Herein, with reference to FIG. 14, a difference in selection of a relocation execution directory depending on a policy setting condition is explained. FIG. 14 is a view illustrating a state of two relocation target directories. For example, a case where a relocation target directory A and a relocation target directory B are in the state illustrated in FIG. 14 is explained.

For example, in this state, as illustrated in a column 401, the average number of accesses of the relocation target directory A is larger than the average number of accesses of the relocation target directory B. Accordingly, in this state, when a condition for the promotion policy is set using the average number of accesses, the relocation target directory A is promoted in priority to the relocation target directory B. On the other hand, as illustrated in a column 402, the total number of accesses of the relocation target directory B is larger than the total number of accesses of the relocation target directory A. Accordingly, in this state, when a condition for the promotion policy is set using the total number of accesses, the relocation target directory B is promoted in priority to the relocation target directory A. In this manner, a different relocation target directory is set as a relocation execution directory depending on the setting condition for the promotion policy. Accordingly, a person in charge preferably selects the promotion policy and the demotion policy as appropriate so as to allow suitable relocation of the files corresponding to the practical use state to be performed.

The movement determination unit 12 notifies the file movement unit 13 of information on the extracted relocation execution directory together with information indicating which one of demotion and promotion is executed. The movement determination unit 12 corresponds to an example of the “movement target selection unit”.

The file movement unit 13 receives information on a relocation execution directory and information indicating which one of demotion and promotion is executed on the relocation execution directory, from the movement determination unit 12.

The file movement unit 13 uses the tier management table 51 to specify a file under the designated relocation execution directory. The file movement unit 13 then executes the designated processing of demotion or promotion on the specified file to perform the relocation of the file, and changes the tier in the storage medium at which the file is present.

The request processing unit 14 receives a processing request to a file, such as a reading request or a writing request, from a server 2. The request processing unit 14 then acquires a storage location of the file designated by the processing request from the tier management table 51. The request processing unit 14 then executes the designated processing for the file in the acquired storage location.

The request processing unit 14 then updates information on the file as a target of the executed processing in the tier management table 51 in accordance with the executed processing. For example, the request processing unit 14 updates the number of accesses and the last reference date/time in the tier management table 51. Note that, when a file is deleted, the request processing unit 14 updates information on the file deleted, from the tier management table 51 in the control directory. Moreover, when a file is added, the request processing unit 14 updates information on the file added to the tier management table 51 in the control directory.

Moreover, the request processing unit 14 further updates information on the file as a target of the processing in each of the metadata 53 and the FCL 54.

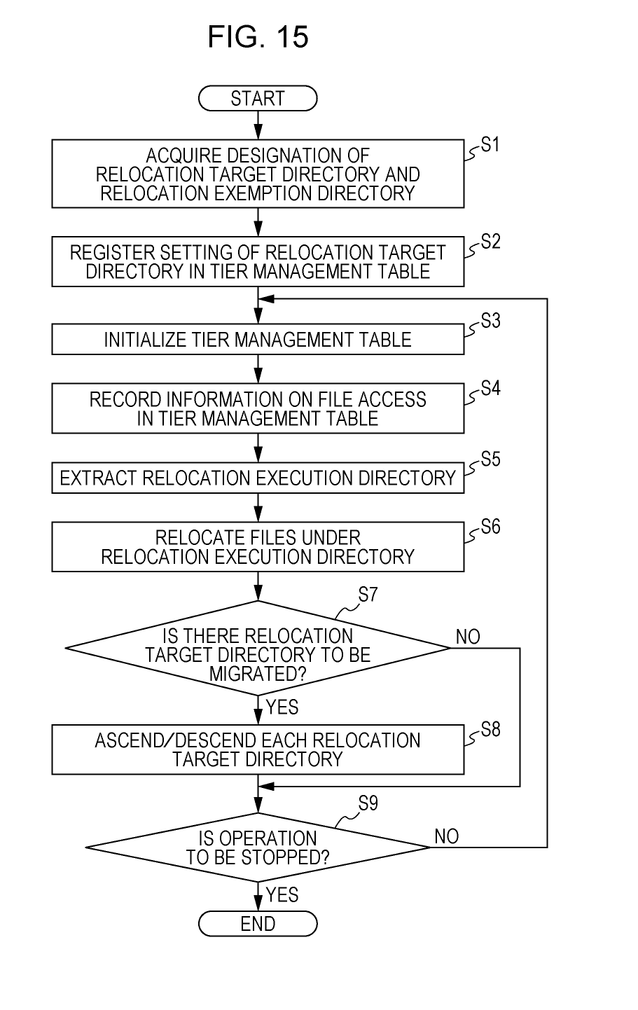

Next, with reference to FIG. 15, an overall flow of relocation processing of files by the storage apparatus 1 according to the first embodiment is explained. FIG. 15 is a flowchart of relocation processing of files by the storage apparatus according to the first embodiment.

The group management unit 11 acquires designation by an operator of a relocation target directory and a relocation exemption target directory (Step S1). The group management unit 11 further acquires information such as an inode number, a delete deadline, and an upper limit value and a lower limit value of the access as setting information on the relocation target directory.

Next, the group management unit 11 registers information on the acquired relocation target directory and relocation exemption target directory in the tier management table 51. In addition, the group management unit 11 uses the setting information on the relocation target directory to register setting of the relocation target directory in the tier management table 51 (Step S2).

Thereafter, the group management unit 11 initializes the tier management table 51 (Step S3). Specifically, the group management unit 11 initializes information such as the number of the number of accesses and the last reference date/time in the tier management table 51.

The request processing unit 14 performs processing to each file in accordance with a processing request from the server 2, and records information on a file access by the executed processing in the tier management table 51 (Step S4).

The movement determination unit 12 extracts a relocation target directory which satisfies the promotion policy or the demotion policy as a relocation execution directory (Step S5).

Next, the movement determination unit 12 notifies the file movement unit 13 of information on the relocation execution directory and information on whether promotion or demotion processing is to be executed. In accordance with the received notification, the file movement unit 13 executes relocation of files under the relocation execution directory (Step S6).

The group management unit 11 uses the tier management table 51 to determine whether a relocation target directory to be a migration target of the directory tier is present based on the number of accesses, the upper limit value and the lower limit value of each relocation target directory (Step S7). If no relocation target directory as a migration target is present (Step S7: negative), the group management unit 11 proceeds the processing to Step S9.

On the other hand, if a relocation target directory as a migration target is present (Step S7: affirmative), the group management unit 11 executes processing of making ascending or descending of a directory tier to which the relocation target directory that is a migration target belongs (Step S8).

The group management unit 11, the movement determination unit 12, and the file movement unit 13 then determine whether to stop an operation of the storage apparatus 1 (Step S9). If the operation is to be stopped (Step S9: affirmative), the group management unit 11, the movement determination unit 12, and the file movement unit 13 end the movement processing of files.

On the other hand, if the operation of the storage apparatus 1 is to be continued (Step S9: negative), the processing executed by the storage apparatus 1 returns to Step S3.

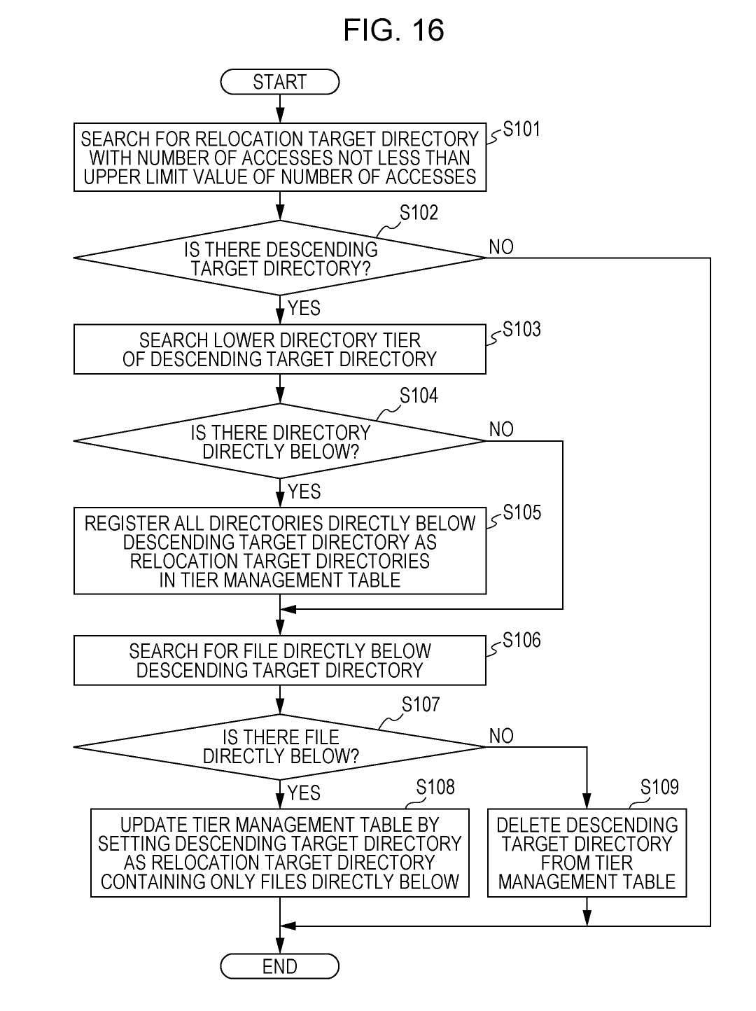

Next, with reference to FIG. 16, descending processing of a directory tier is explained. FIG. 16 is a flowchart of descending processing of a directory tier.

The group management unit 11 searches a relocation target directory with the number of accesses not less than an upper limit value of the number of accesses in the tier management table 51 (Step S101).

The group management unit 11 determines whether a descending target directory with the number of accesses not less than the upper limit value is present (Step S102). If no descending target directory is present (Step S102: negative), the group management unit 11 ends the descending processing.

On the other hand, if a descending target directory is present (Step S102: affirmative), the group management unit 11 uses the metadata 53 to search a directory tier of a lower level than the descending target directory (Step S103).

The group management unit 11 then determines whether a directory is present directly below the descending target directory (Step S104). If no directory is present directly below (Step S104: negative), the group management unit 11 proceeds the processing to Step S106.

On the other hand, if a directory is present directly below (Step S104: affirmative), the group management unit 11 registers all directories directly below the descending target directory as relocation target directories in the tier management table 51 (Step S105).

Next, the group management unit 11 uses the metadata 53 to search a file directly below the descending target directory (Step S106).

The group management unit 11 then determines whether a file is present directly below the descending target directory (Step S107). If a file is present directly below (Step S107: affirmative), the group management unit 11 updates the tier management table 51 so as to set the descending target directory as a relocation target directory targeted for only files directly below (Step S108).

On the other hand, if no file is present directly below (Step S107: negative), the group management unit 11 deletes the descending target directory from the tier management table 51 (Step S109).

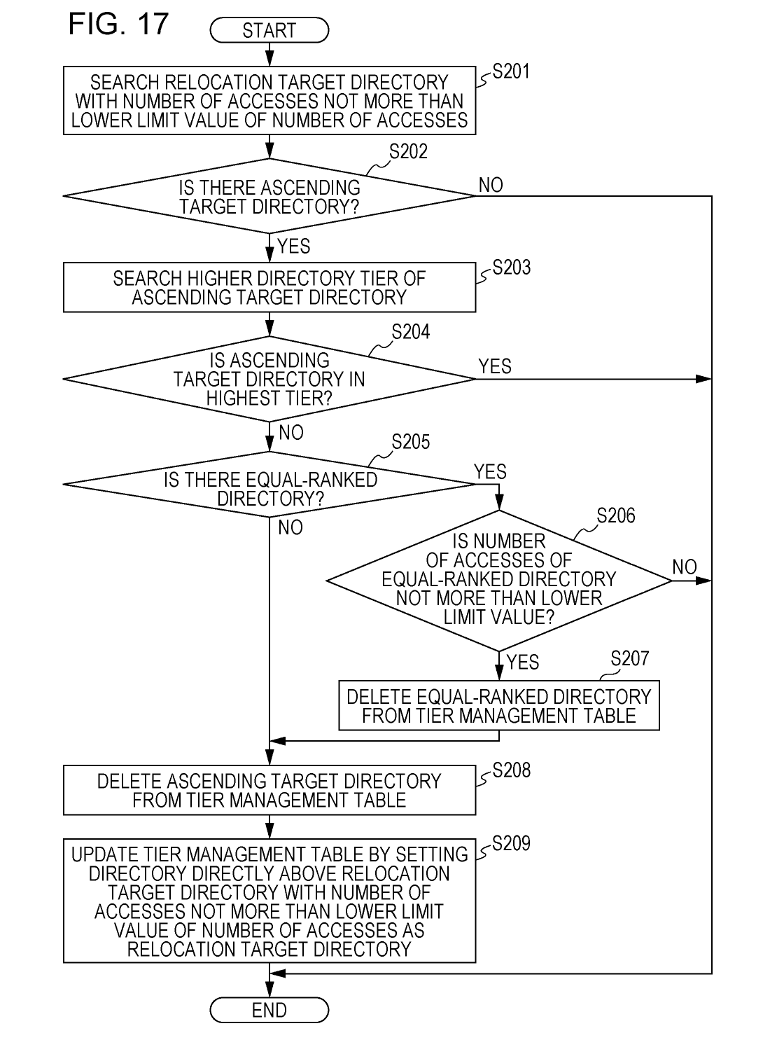

Next, with reference to FIG. 17, ascending processing of a directory tier is explained. FIG. 17 is a flowchart of ascending processing of a directory tier.

The group management unit 11 searches a relocation target directory with the number of accesses not more than a lower limit value of the number of accesses in the tier management table 51 (Step S201).

The group management unit 11 determines whether an ascending target directory with the number of accesses not more than the lower limit value is present (Step S202). If no ascending target directory is present (Step S202: negative), the group management unit 11 ends the ascending processing.

On the other hand, if the ascending target directory is present (Step S202: affirmative), the group management unit 11 uses the metadata 53 to search a directory tier of a higher level than the ascending target directory (Step S203).

The group management unit 11 then determines whether the ascending target directory is a highest-level tier directory (Step S204). If it is a highest-level tier directory (Step S204: affirmative), the group management unit 11 ends the ascending processing.

On the other hand, if it is not a highest-level tier directory (Step S204: negative), the group management unit 11 determines whether an equal-ranked directory under the same directory and at the same tier is present (Step S205). If no equal-ranked directory is present (Step S205: negative), the group management unit 11 proceeds the processing to Step S208.

On the other hand, if an equal-ranked directory is present (Step S205: affirmative), the group management unit 11 determines whether the number of accesses of the equal-ranked directory is not more than a lower limit value of the number of accesses (Step S206). If it is larger than the lower limit value (Step S206: negative), the group management unit 11 ends the ascending processing.

On the other hand, if it is not more than the lower limit value (Step S206: affirmative), the group management unit 11 deletes the equal-ranked directory from the tier management table 51 (Step S207).

The group management unit 11 then deletes the ascending target directory from the tier management table 51 (Step S208).

In addition, the group management unit 11 updates the tier management table 51 so as to set a directory higher by one level than the relocation target directory with the number of accesses not more than the lower limit value of the number of accesses as a relocation target directory (Step S209).

As described above, the storage apparatus according to the first embodiment divides files into groups, determines whether each group satisfies a condition for relocation, and performs relocation of the files which belong to each group. This may omit the search processing of the metadata or the analysis processing of the FCL in the relocation, thereby allowing the load to the CPU to be reduced and the processing time to be shortened.

Moreover, no FCL is used for the relocation to allow a configuration in which no FCL is located in the storage apparatus. When a FCL is used for the relocation of files, the increased number of files used for determination of the relocation results in the enormous FCL. In contrast, the configuration in which no FCL is located may reduce a pressure to a disk area due to the increased number of files used for determination of the relocation.

### Second Embodiment

Next, a second embodiment is explained. A storage apparatus according to the second embodiment is different from that in the first embodiment in that a relocation target directory is automatically determined by grouping of directories. The storage apparatus according to the second embodiment is also illustrated by the block diagram of FIG. 1. In the following explanation, an explanation of the function of each unit the same as that in the first embodiment is omitted.

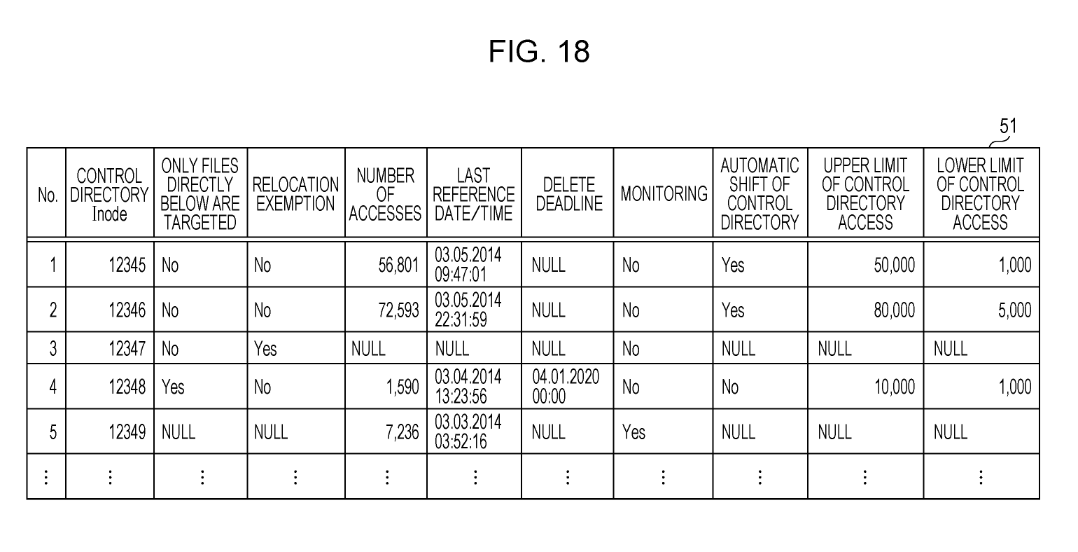

FIG. 18 is a view of an example of a tier management table according to the second embodiment. As illustrated in FIG. 18, a tier management table 51 according to the second embodiment includes an item of monitoring in addition to the items similar to those in the first embodiment. A person in charge sets a value of the monitoring.

A value of the monitoring being “Yes” indicates that a relocation target directory is set as a grouping target. On the other hand, if a value of the monitoring being “No” indicates that a relocation target directory is not set as a grouping target. Hereinafter, a relocation target directory with a value of the monitoring being “Yes” is referred to as a relocation target directory of a “monitoring target”.

Moreover, in the second embodiment, the relocation policy definition 52 includes a relocation policy for each directory.

When no relocation target directory is set, the group management unit 11 targets for all directories to determine a highest-level directory, out of directories including directories each of which having the same relocation policy, as a relocation target directory.

Moreover, before the directory tier migration processing of the relocation target directory, the group management unit 11 refers to the tier management table 51 to determine whether each relocation target directory at that point is a monitoring target.

Next, if a relocation target directory of a monitoring target is present, the group management unit 11 acquires relocation policies sequentially from, out of directories under the relocation target directory, the directory at the lowest layer toward the directory at the higher level, from the relocation policy definition 52. The group management unit 11 then descends the directory tier of a highest-level directory out of directories including directories each of which having the same relocation policy, as a relocation target directory.

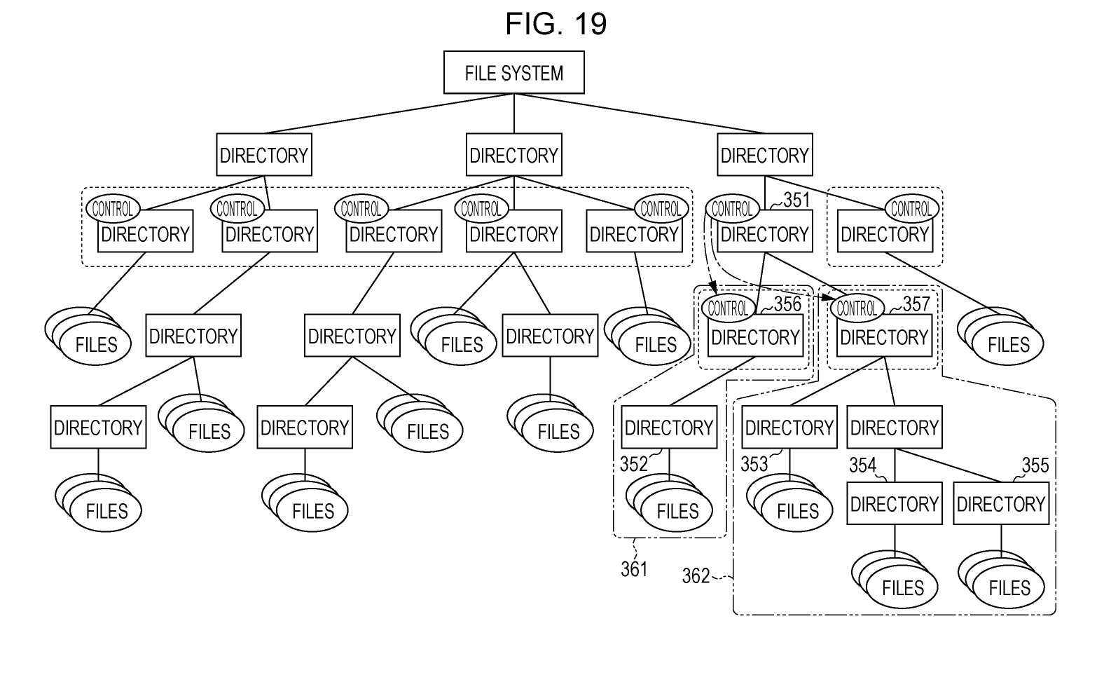

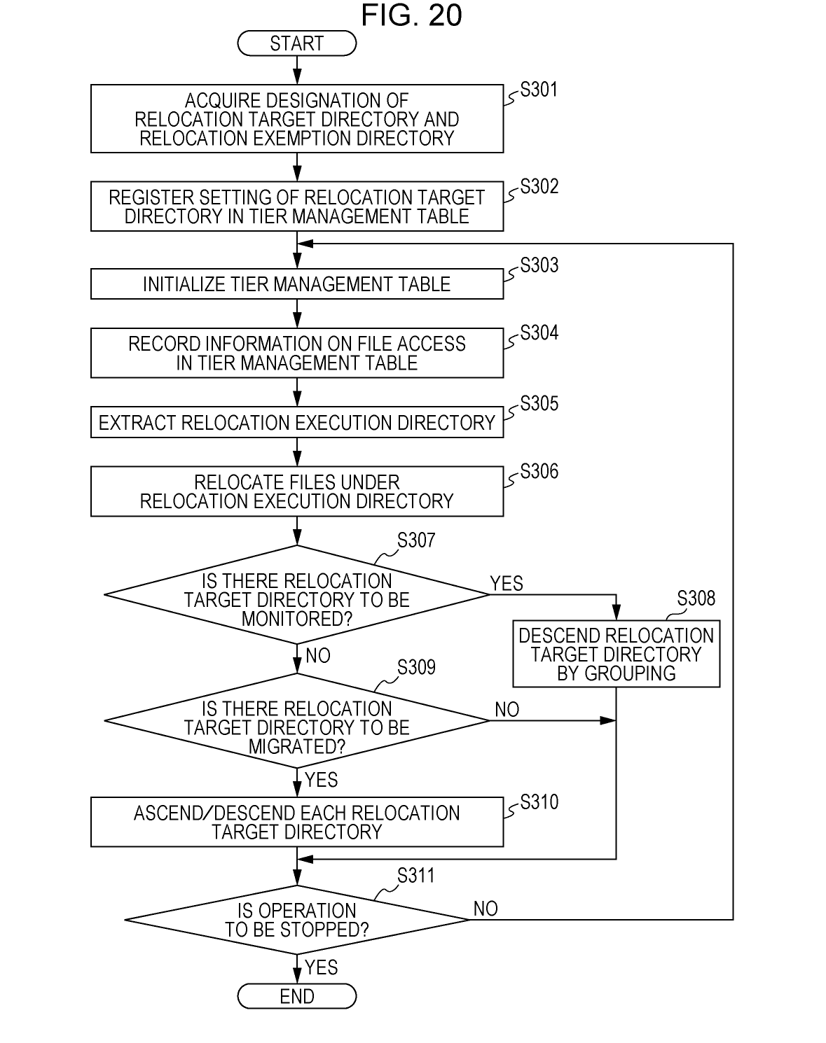

Herein, with reference to FIG. 19, descending processing of a relocation target directory by grouping is explained. FIG. 19 is a view of an example where a relocation target directory is descended by grouping.

A case where a directory 351 is a relocation target directory is explained. Before migration of a directory, the group management unit 11 uses the tier management table 51 to determine whether relocation target directories including a directory 351 are monitoring targets.

The group management unit 11 then acquires relocation policies of directories 352 to 355 that are directories at the lowest layer, out of directories under the directory 351, from the relocation policy definition 52 because the directory 351 is a monitoring target.

In this case, the relocation policies of the directory 352 and the directories 353 to 355 are different from each other. Accordingly, the group management unit 11 goes back in the higher-level direction of the directory tier from the directory 352, and specifies a directory 356 as a highest-level directory out of directories with the identical relocation policy. Moreover, the group management unit 11 goes back in the higher-level direction of the directory tier from the directories 353 to 355, and specifies a directory 357 as a highest-level directory out of directories with the identical relocation policy.

The group management unit 11 then descends the relocation target directory from the directory 351 to the directories 356 and 357. In this case, directories surrounded by a frame 361 are treated as one group including the directory 356 having become the relocation target directory at the highest level. Moreover, directories surrounded by a frame 362 are treated as one group including the directory 357 having become the relocation target directory at the highest level.

Herein, although a case where a relocation target directory is already set has been explained, the group management unit 11 creates a group by the similar processing, and determines a relocation target directory when no relocation target directory is set.

Next, with reference to FIG. 20, an overall flow of relocation processing of files by the storage apparatus 1 according to the second embodiment is explained. FIG. 20 is a flowchart of relocation processing of files by the storage apparatus according to the second embodiment.

The group management unit 11 acquires designation by an operator of a relocation target directory and a relocation exemption target directory (Step S301). The group management unit 11 further acquires information such as an inode number, a delete deadline, and an upper limit value and a lower limit value of the access as setting information on the relocation target directory.

Next, the group management unit 11 registers information on the acquired relocation target directory and relocation exemption target directory in the tier management table 51. In addition, the group management unit 11 uses the setting information on the relocation target directory to register setting of the relocation target directory in the tier management table 51 (Step S302).

Thereafter, the group management unit 11 initializes the tier management table 51 (Step S303). Specifically, the group management unit 11 initializes information such as the number of accesses and the last reference date/time in the tier management table 51.

The request processing unit 14 performs processing to each file in accordance with a processing request from the server 2, and records information on a file access by the executed processing in the tier management table 51 (Step S304).

The movement determination unit 12 extracts a relocation target directory which satisfies the promotion policy or the demotion policy as a relocation execution directory (Step S305).

Next, the movement determination unit 12 notifies the file movement unit 13 of information on the relocation execution directory and information on whether promotion or demotion processing is to be executed. In accordance with the received notification, the file movement unit 13 executes relocation of files under the relocation execution directory (Step S306).

The group management unit 11 uses the tier management table 51 to determine whether a relocation target directory of a monitoring target is present (Step S307). If a relocation target directory of a monitoring target is present (Step S307: affirmative), the group management unit 11 checks a relocation policy for a directory under the relocation target directory of a monitoring target in the relocation policy definition 52. The group management unit 11 then performs grouping such that a highest-level directory out of directories having only the same relocation policy as a relocation target directory, and causes the relocation target directory to be descended (Step S308). The group management unit 11 then proceeds the processing to Step S311.

On the other hand, if no relocation target directory of a monitoring target is present (Step S307: negative), the group management unit 11 uses the tier management table 51 to determine whether a relocation target directory to be a migration target of the directory tier is present (Step S309). Specifically, the group management unit 11 determines whether a relocation target directory to be a migration target of the directory tier is present based on the number of accesses, the upper limit value and the lower limit value of each relocation target directory. If no relocation target directory as a migration target is present (Step S309: negative), the group management unit 11 proceeds the processing to Step S311.

On the other hand, if a relocation target directory as a migration target is present (Step S309: affirmative), the group management unit 11 executes processing of making ascending or descending of a directory tier to which the relocation target directory that is a migration target belongs (Step S310).

The group management unit 11, the movement determination unit 12, and the file movement unit 13 then determine whether an operation of the storage apparatus 1 is to be stopped (Step S311). If the operation is to be stopped (Step 311: affirmative), the group management unit 11, the movement determination unit 12, and the file movement unit 13 end the movement processing of files.

On the other hand, if the operation of the storage apparatus 1 is to be continued (Step S311: negative), the processing executed by the storage apparatus 1 returns to Step S303.

As described above, the storage apparatus according to the second embodiment may automatically determine a relocation target directory by grouping of directories. This allows a relocation execution directory to be automatically set when a person in charge does not set a relocation execution directory or desires to descend a relocation execution directory, thereby making it possible to simplify a labor by the person in charge.

### Third Embodiment

Next, a third embodiment is explained. A storage apparatus according to the third embodiment is different from that in the first embodiment in that a storage medium to which files are located is changed by considering a free-space state of a high-level storage medium. The storage apparatus according to the third embodiment is also illustrated by the block diagram of FIG. 1. In the following explanation, an explanation of the function of each unit the same as that in the first embodiment is omitted.

After executing a determination of relocation of files targeted with a relocation target disk and before actually executing the relocation of files, the movement determination unit 12 calculates the amount of data to be migrated to each Tier using the metadata 53 based on a result of the relocation determination. The movement determination unit 12 then calculates the amounts of space of the Flash 151 and the SAS 152.

Further, if determining that the amount of space lager than an upper limit of the amount determined in advance is generated in the Flash 151 or the SAS 152, the movement determination unit 12 specifies a directory with a shorter non-access period or a relocation target directory with a higher access frequency than that of other directories. The movement determination unit 12 then locates the specified relocation target directory with the higher access frequency in the Flash 151 or the SAS 152. This allows a larger number of files to be located in high-level directories to enhance the efficient use of the storage medium, thereby allowing the processing efficiency to be improved.

On the other hand, if no amount of space is present in the Flash 151 or in the SAS 152 or the amount of space is less than a lower limit of the amount determined in advance, the movement determination unit 12 specifies a relocation target directory with a lower access frequency out of relocation target directories. The movement determination unit 12 then locates the specified relocation target directory with the lower access frequency in a lower-level storage medium. This may secure the amount of space in the high-level storage medium, thereby making it possible to implement more efficient arrangement of files.

As described above, the storage apparatus according to the third embodiment determines a relocation target directory for which the relocation is performed, and then adjusts the relocation target directory for which the relocation is performed in accordance with a free-space state of the storage medium. This allows files to be arranged more appropriately, thereby making it possible to improve the processing ability of the storage apparatus.

(Hardware Configuration)

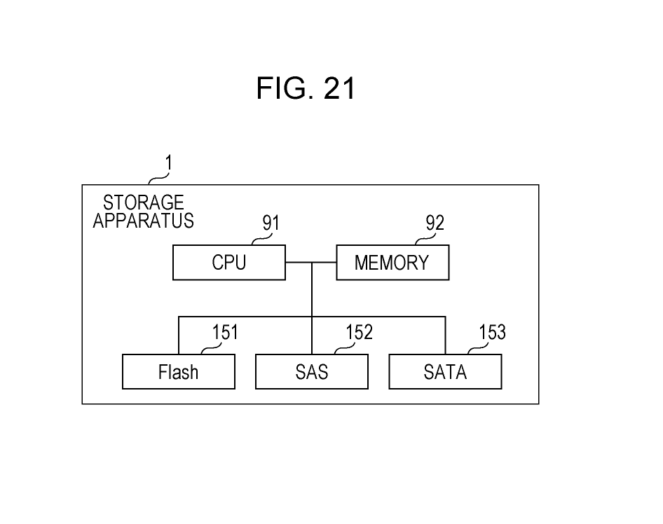

FIG. 21 is a hardware configuration diagram of the storage apparatus 1. The storage apparatus 1 includes a central processing unit (CPU) 91, a memory 92, the Flash 151, the SAS 152, and the SATA 153.

The Flash 151 stores therein various kinds of programs including programs for implementing the processing of each of the movement determination unit 12, the file movement unit 13, and the request processing unit 14 which are exemplified in FIG. 1.

The CPU 91 implements the processing of each of the movement determination unit 12, the file movement unit 13, and the request processing unit 14 which are exemplified in FIG. 1 by reading the various kinds of programs from the Flash 151, and executing the programs by being developed on the memory 92.

Herein, although various kinds of programs are stored in the Flash 151 for quickly executing the processing in the foregoing, the embodiments are not limited to this, but various kinds of programs may preferably be stored in the SAS 152 and the SATA 153. Moreover, although the example where the Flash 151 stores therein the tier management table 51, the relocation policy definition 52, the metadata 53, and the FCL 54 is explained in the embodiments, the storage location therefor is not limited to this, but, for example, the SAS 152 and the SATA 153 may store therein these components.

Moreover, although the example where a file reprocessing process is present in the storage apparatus 1 is explained in the explanation in the foregoing, but, for example, a file relocation processing process may preferably be operated on the server 2. In that case, a storage apparatus control program which implements the processing of each of the movement determination unit 12, the file movement unit 13, and the request processing unit 14 is executed by the CPU on the server 2 to implement the respective functions.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage apparatus comprising:
a storage unit to include a plurality of tiers;
a group management unit to manage files stored in any of the tiers in the storage unit by dividing the files into a plurality of groups;
a movement target selection unit to select a group, out of the groups, that satisfies a tier movement condition as a movement target of the tier; and
a file movement unit to move a subordinate file belonging to the group selected by the movement target selection unit, from a tier in which the subordinate file is stored to another tier.

2. The storage apparatus according to claim 1, wherein
the movement target selection unit determines whether a specific group satisfies the tier movement condition, based on an access frequency to the subordinate file in the specific group.

3. The storage apparatus according to claim 2, wherein
the movement target selection unit determines whether the specific group satisfies the tier movement condition, based on an average number of accesses to the subordinate files in the specific group, a total number of the accesses to the subordinate files in the specific group, or an access date/time to the subordinate files in the specific group.

4. The storage apparatus according to claim 3, wherein
the movement target selection unit:
determines whether the access frequency is more than an upper limit threshold value based on the average number of accesses to the subordinate files in the specific group or the total number of the accesses to the subordinate files in the specific group and sets the subordinate files in the specific group as a group to be moved to a higher-level tier when the access frequency is more than the upper limit threshold value, and
determines whether the access frequency is less than a lower limit threshold value based on the access date/time to the subordinate files in the specific group and sets the subordinate files in the specific group as a group to be moved to a lower-level tier when the access frequency is less than the lower limit threshold value.

5. The storage apparatus according to claim 2, wherein
the movement target selection unit determines whether to select the specific group as a movement target of the tier based on an amount of free space in a tier at a movement destination, in addition to whether the specific group satisfies the tier movement condition.

6. The storage apparatus according to claim 2, wherein
the group management unit merges or divides the groups, based on the access frequency to the subordinate files in the groups to be managed.

7. The storage apparatus according to claim 6, wherein
the group management unit:
divides any of the groups to be managed when a total number of accesses to the subordinate files in the groups to be managed is not less than an predetermined upper limit value, and
merges any two or more in the groups to be managed when the total number of accesses to the subordinate files in the groups to be managed is not more than a predetermined lower limit value.

8. The storage apparatus according to claim 1, wherein
the group management unit uses a directory as a group.

9. The storage apparatus according to claim 1, wherein
the movement target selection unit does not select a group designated in advance as a target of the movement.

10. The storage apparatus according to claim 1, wherein
the tiers are classified in accordance with processing speeds of storage media included in the storage unit, and a higher-level tier has a faster processing speed.

11. A method for controlling a storage apparatus that includes a storage unit, the control method comprising:
managing, by a processor, files stored in any of a plurality of tiers included in the storage unit of the storage apparatus by dividing the files into a plurality of groups;
selecting, by the processor, a group, out of the groups, that satisfies a tier movement condition as a movement target of the tier; and
moving, by the processor, a subordinate file belonging to the selected group from a tier in which the subordinate file is stored to another tier.
